(19) United States
(12) Patent Application Publication
(10) Pub. No.: US 2018/0319514 A1
(43) Pub. Date: Nov. 8, 2018

(54) FLUID COUPLER

(71) Applicant: Eaton Intelligent Power Limited, Dublin 4 (IE)

(72) Inventors: Parag More, Kothrud Pune (IN); Ashok K. Vishwakarma, Pune (IN)

(21) Appl. No.: 15/961,070

(22) Filed: Apr. 24, 2018

Related U.S. Application Data
(60) Provisional application No. 62/501,281, filed on May 4, 2017.

(51) Int. Cl. B64F 1/28; B60K 15/04

(52) U.S. Cl. CPC B64F 1/28; B60K 2015/0483; B60K 15/04

(57) ABSTRACT

A fluid coupler includes a housing with an inlet port and an outlet port, a piston disposed in the housing and configured to control fluid flow between the inlet port and the outlet port, and a piston retainer disposed in the housing. A piston may include at least one radially-extending support member, and the radially-extending support member may include an aperture. The at least one radially-extending support member may be substantially planar.

### CROSS-REFERENCE TO RELATED APPLICATION

This application claims the benefit of U.S. Provisional Patent Application Ser. No. 62/501,281, filed on May 4, 2017, the disclosure of which is hereby incorporated herein by reference in its entirety.

### TECHNICAL FIELD

The present disclosure generally relates to fluid systems and fluid couplers, including fluid fuel systems and fluid couplers that may be used with fuel hydrants for aircraft.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Existing fluid systems may include fluid couplers that may wear over time.

There is a desire for solutions/options that minimize or eliminate one or more challenges or shortcomings of fluid couplers. The foregoing discussion is intended only to illustrate examples of the present field and should not be taken as a disavowal of scope.

### SUMMARY

In embodiments, a fluid coupler may include a housing with an inlet port and an outlet port, a piston disposed in the housing and configured to control fluid flow between the inlet port and the outlet port, and/or a piston retainer disposed in the housing. The piston may include at least one radially-extending support member. The radially-extending support member may include an aperture. The at least one radially-extending support member may be substantially planar.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a cross-sectional view of an embodiment of a fluid coupler in accordance with teachings of the present disclosure.

FIG. 2 is a perspective view of a piston in accordance with teachings of the present disclosure.

FIG. 3 is a perspective view of an embodiment of a piston in accordance with teachings of the present disclosure.

FIG. 4 is a cross-sectional view of an embodiment of a piston in accordance with teachings of the present disclosure.

FIG. 5A is a perspective view of an embodiment of a fluid coupler in accordance with teachings of the present disclosure. Some portions are shown as translucent for illustrative purposes.

FIG. 5B is a side view of an embodiment of a fluid coupler in accordance with teachings of the present disclosure. Some portions are shown as translucent for illustrative purposes.

FIG. 5C is cross-sectional view of a portion of the embodiment of a fluid coupler shown in FIG. 5B.

FIG. 5D is a perspective view of an embodiment of a fluid coupler in accordance with teachings of the present disclosure.

FIG. 5E is an enlarged perspective view of a portion of the embodiment of a fluid coupler of FIG. 5D.

FIG. 6 is a perspective view of an embodiment of a piston retainer in accordance with teachings of the present disclosure.

FIG. 7 is a perspective view of an embodiment of a piston retainer in accordance with teachings of the present disclosure.

FIG. 7A is an enlarged perspective view of a portion of the embodiment of a piston retainer of FIG. 7.

FIG. 8 is a perspective view of an embodiment of a piston retainer in accordance with teachings of the present disclosure.

FIG. 8A is an enlarged perspective view of a portion of the embodiment of a piston retainer of FIG. 8.

FIG. 9 generally illustrates a side view of an embodiment of a flow straightener in accordance with teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

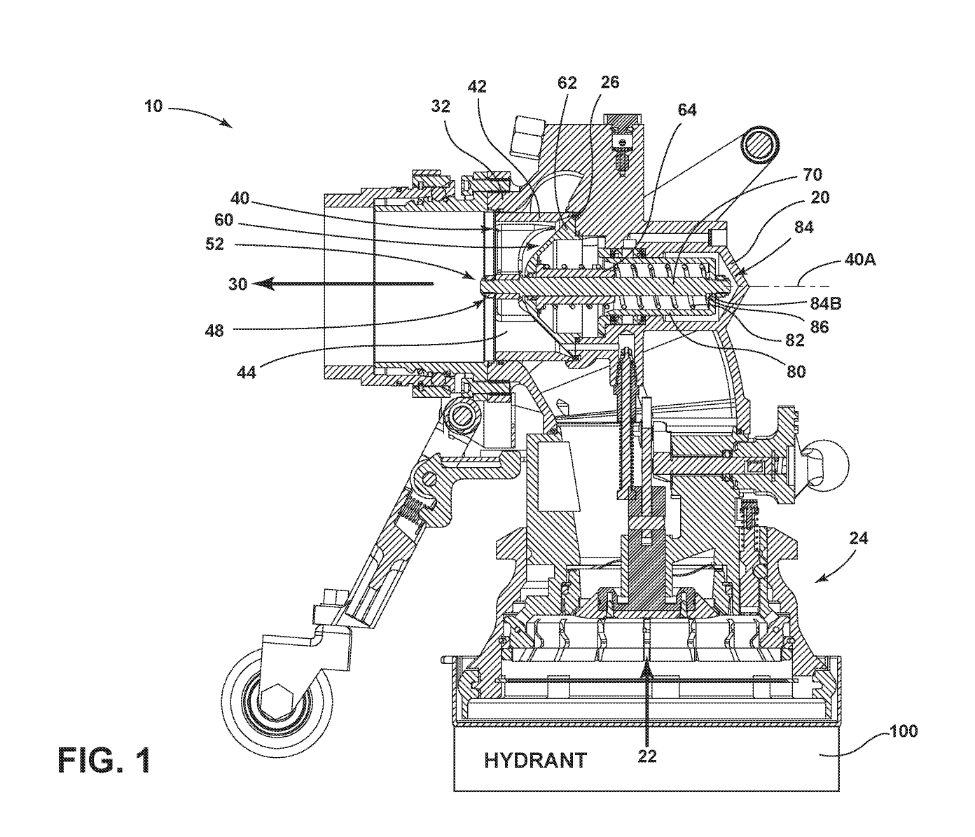

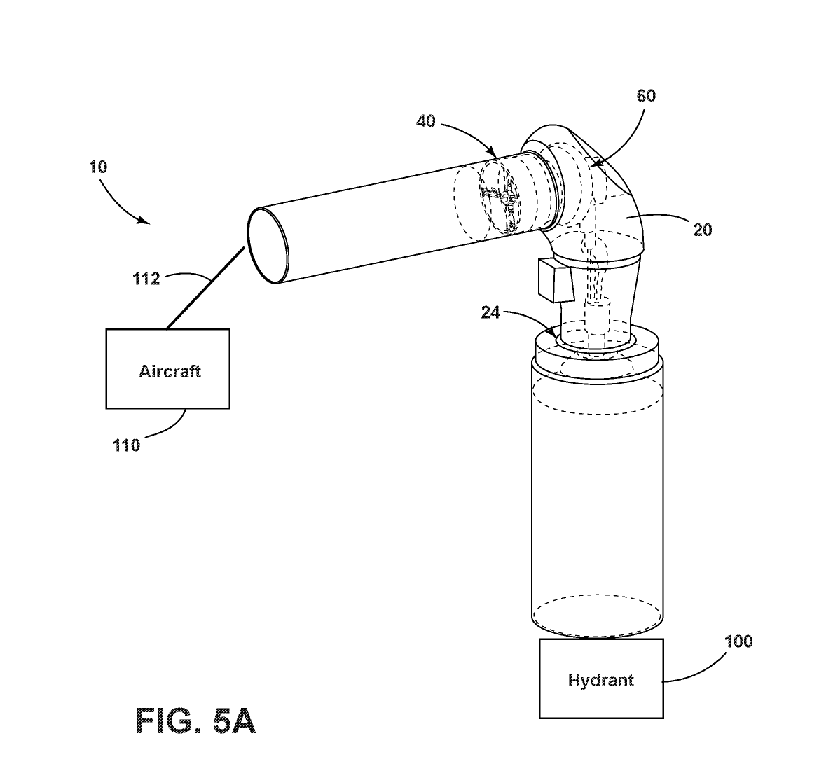

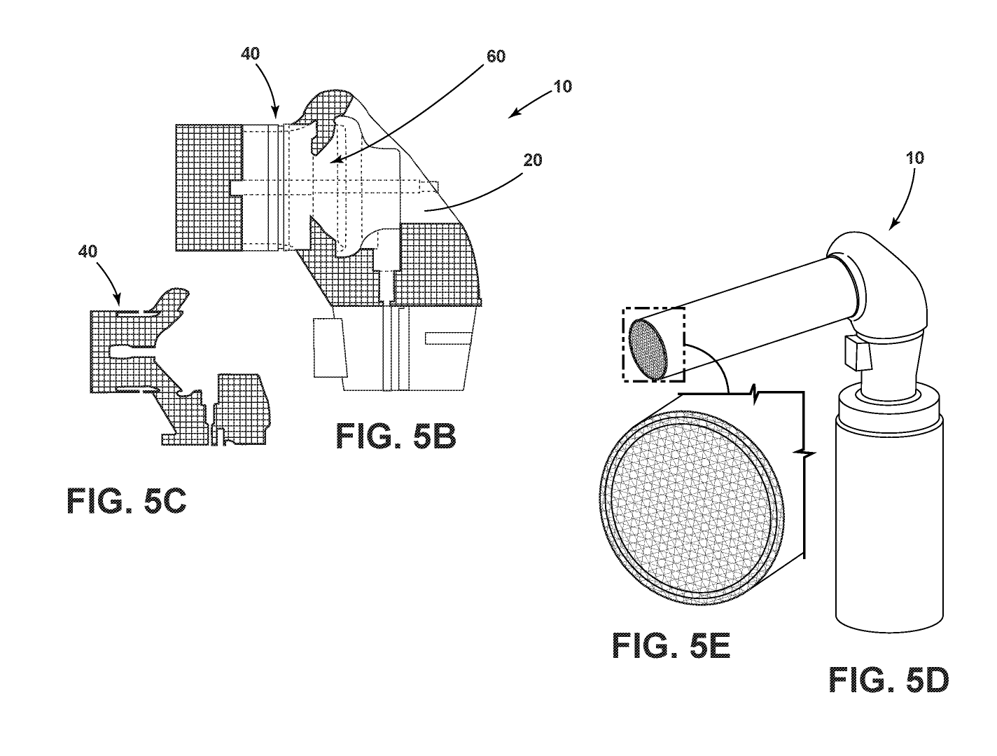

In embodiments, such as generally illustrated in FIG. 1, a fluid coupler 10 may include a housing 20, an inlet 22, an outlet 30, a piston 40, and/or a piston retainer 60. Fluid coupler 10 may be configured for one or more of a variety of applications. For example and without limitation, inlet 22 may be configured for connection with a fuel hydrant 100 that may be disposed at least partially in the ground and/or outlet 30 may be configured for connection with an aircraft 110, such as via a fueling hose 112 (see, e.g., FIG. 5A). Inlet 22 may include a valve 24 that may open upon sufficient or complete connection with another fluid member, such as a fuel hydrant 100. Inlet 22 may include, for example only, an inner diameter of about 176 mm. Outlet 30 may include, for example only, an inner diameter of about 104 mm.

In embodiments, a piston 40 may control flow of fluid through housing 20 between inlet 22 and outlet 30. For example and without limitation, piston 40 may include a closed position in which piston 40 prevents fluid flow between inlet 22 and outlet 30 (see, e.g., FIG. 1) and may include an open position in which piston 40 prevents fluid flow between inlet 22 and outlet 30 (see, e.g., FIGS. 5A and 5B). Piston 40 may include a central/longitudinal axis 40A.

As generally illustrated in FIGS. 1, 3, 4, 5A, and 5B, with embodiments, a piston 40 may include one or more of a variety of shapes, sizes, configurations, and/or materials. For example and without limitation, piston 40 may include a generally cylindrical outer wall 42 and may include one or more support members 44 that may connect outer wall 42 with an inner portion 48 that may be disposed at or about a center of piston 40 (e.g., may be centered about piston axis 40A). Outer wall 42 may be configured to engage housing 20, such as via a sealing member 32, to provide a fluid seal between inlet 22 and outlet 30. Inner portion 48 may be configured to receive (e.g., include a recess or aperture 50 for) a connecting member 70 that may be configured for guiding and/or selectively actuating piston 40 between open and closed positions. Connecting member 70 may include, for example, a rod or a shaft. In embodiments, piston 40 may be generally hollow. In an open position of piston 40, fluid may be permitted to flow, for example, from inlet 22 within outer wall 42 of piston 40 and past/around supporting members 44 and/or inner portion 48 to outlet 30.

With embodiments, support members 44 may extend substantially in a radial direction (e.g., relative to piston/central axis 40A) and may be generally planar. For example and without limitation, support members 44 may extend substantially parallel with planes defined by the axial and radial directions and that may be substantially perpendicular to a circumferential direction.

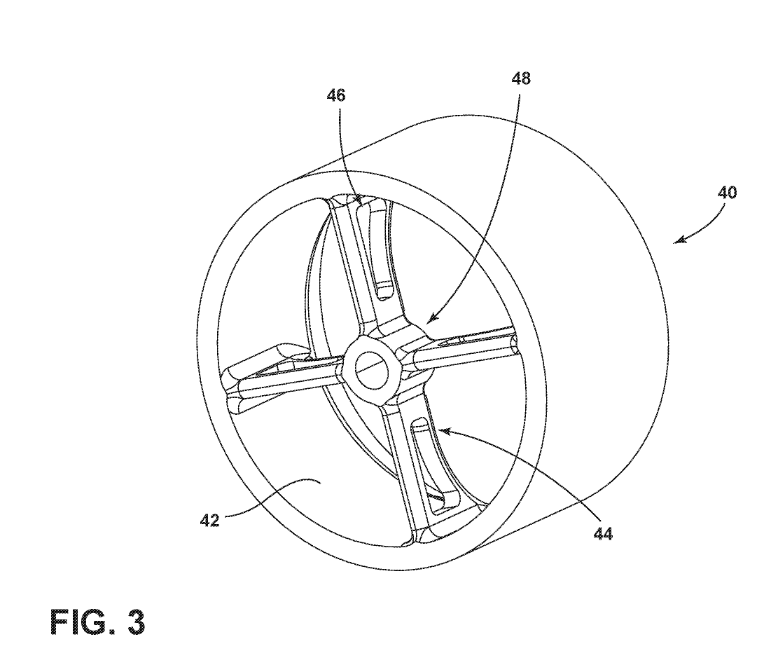

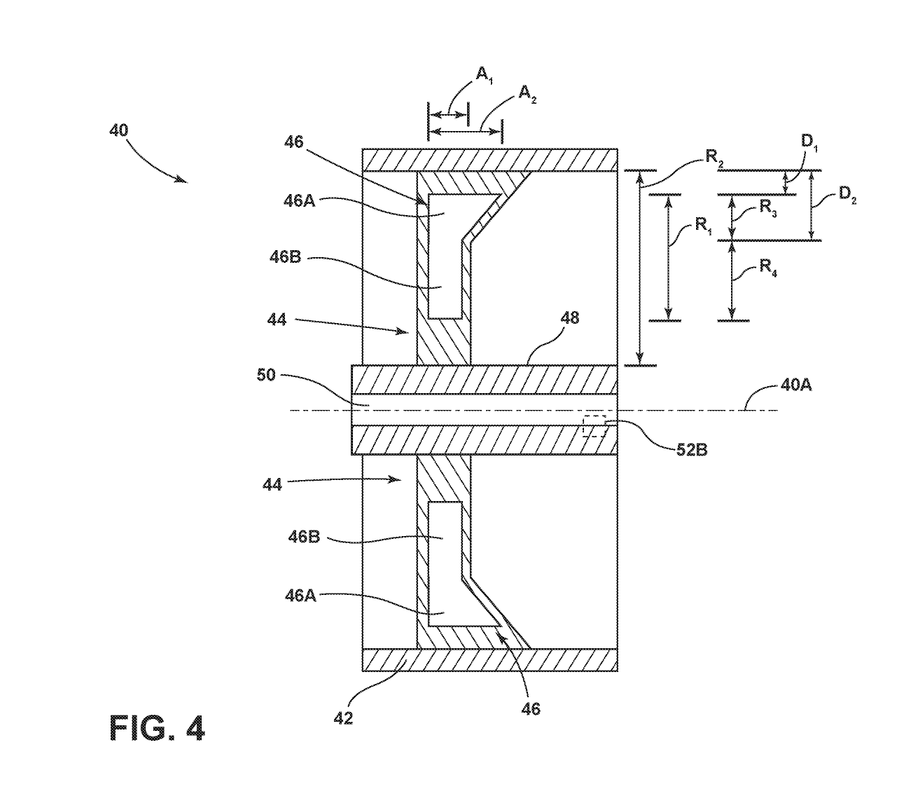

In embodiments, such as generally illustrated in FIGS. 3 and 4, support members 44 may include one or more apertures 46. Apertures 46 may comprise a cut-out portion and may include one or more of a variety of shapes, sizes, and/or configurations. For example and without limitation, apertures 46 may include a generally L-shaped configuration that may include a first/wide portion 46A (e.g., with a relatively greater axial dimension A₁) and a second/skinnier portion 46B (e.g., with a relatively smaller axial dimension A₂). The radial extent R₃ of the second portion 46B may be different from (e.g., greater than) the radial extent R₄ of the first portion 46A. The first portion 46A may be disposed at a first distance D₁ from the outer wall 42, the second portion 46B may be disposed at a second distance D₂ from the outer wall 42, and/or the second distance D₂ may be greater than the first distance D₁.

With embodiments, the size of an aperture 46 may, in embodiments, be at least half of the size of a support member 44. For example and without limitation, an aperture 46 may effectively reduce the volume and/or the surface area of a support member 44 by at least half. The radial extent R₁ of aperture 46 may be at least half of the radial extent R₂ of support member 44.

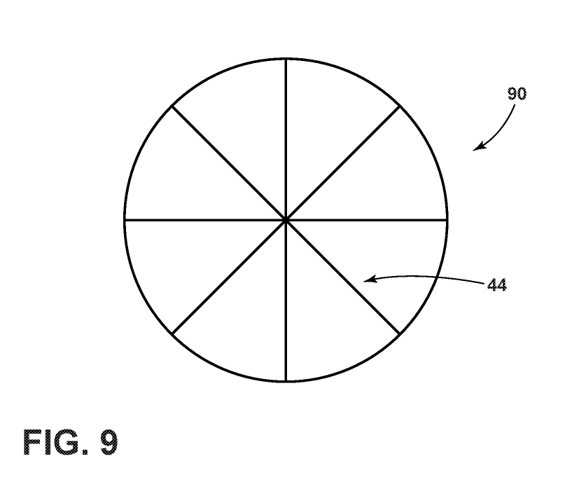

In embodiments, a piston 40 may include a plurality of support members 44. The plurality of support members 44 may include, for example, four radially-extending support members 44 (see, e.g., FIG. 3) or six radially-extending support members 44 (see, e.g., FIG. 9), each of which may include a respective aperture 46. Support members 44 may or may not be equally circumferentially spaced from each other. Apertures 46 may be formed into sides of supporting members 44 (e.g., from a circumferential direction) and may not be visible if piston 40 is viewed along axis 40A of piston 40. Apertures 46 may permit fluid to flow through support members 44, which may reduce the force/torque applied to support members 44 by fluid in housing 20 (e.g., when piston 40 is in an open position).

With embodiments, such as generally illustrated in FIGS. 1, 5B, 6, 7, 7A, 8, and 8A, a piston retainer 60 may include one or more of a variety of shapes, sizes, configurations, and/or materials. Piston retainer 60 may include a generally conical or dome-shaped body 62. Piston retainer 60 may include a cylindrical collar 64 that may be configured to receive, support, and/or be supported by connecting member 70. Collar 64 may be configured such that connecting member 70 may slide within collar 64. Collar 64 may extend, for example, at least partially within body 62 and/or may extend beyond body 62 (e.g., axially). Body 62 of piston retainer 60 may be connected (e.g., fastened, coupled, immovably fixed, etc.) to housing 20, such as via one or more fasteners 26 that may, for example, be disposed at or about an outer edge of body 62.

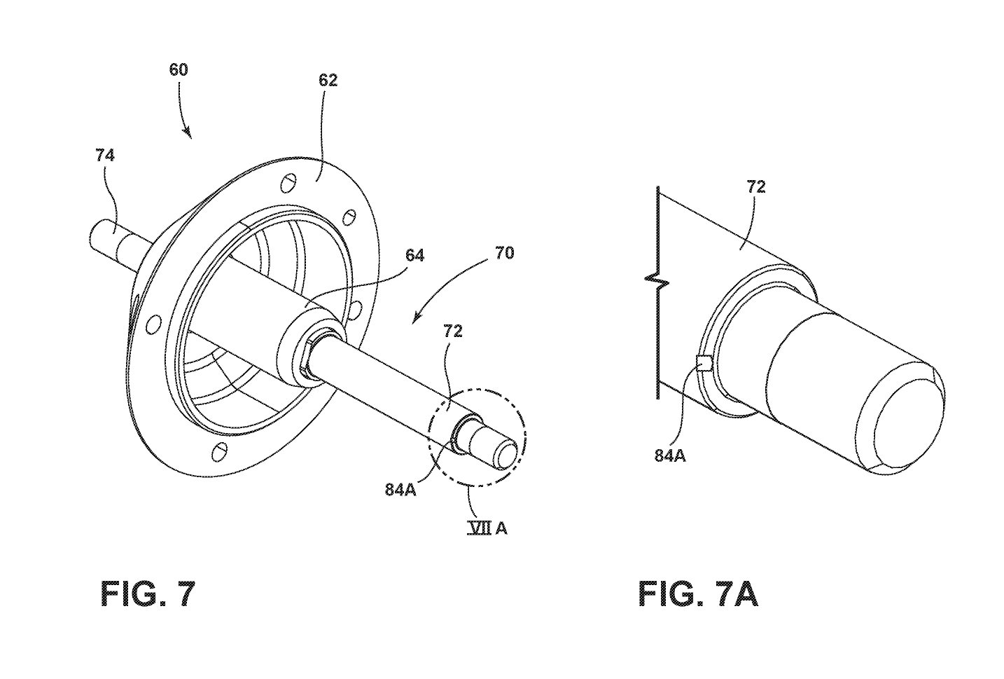

With embodiments, such as generally illustrated in FIGS. 1, 7, and 7A, connecting member 70 may be connected with an inner housing 80 via a keyed engagement 84 which may prevent connecting member 70 from rotating relative to inner housing 80. For example and without limitation, connecting member 70 may include a male element/feature 84A configured to be received by a female element/feature 84B of inner housing 80. Additionally or alternatively, compression forces between connecting member 70, a washer 86, and inner housing 80 may restrict movement (e.g., rotational movement) of connecting member 70. Inner housing 80 may be connected with housing 20 such that inner housing 80 may slide relative to housing 20 but may not rotate relative to housing 20. A spring 82 may be connected between piston retainer 60 and inner housing 80 such that spring 82 biases inner housing 80 toward a closed position that may correspond to the closed position of piston 40.

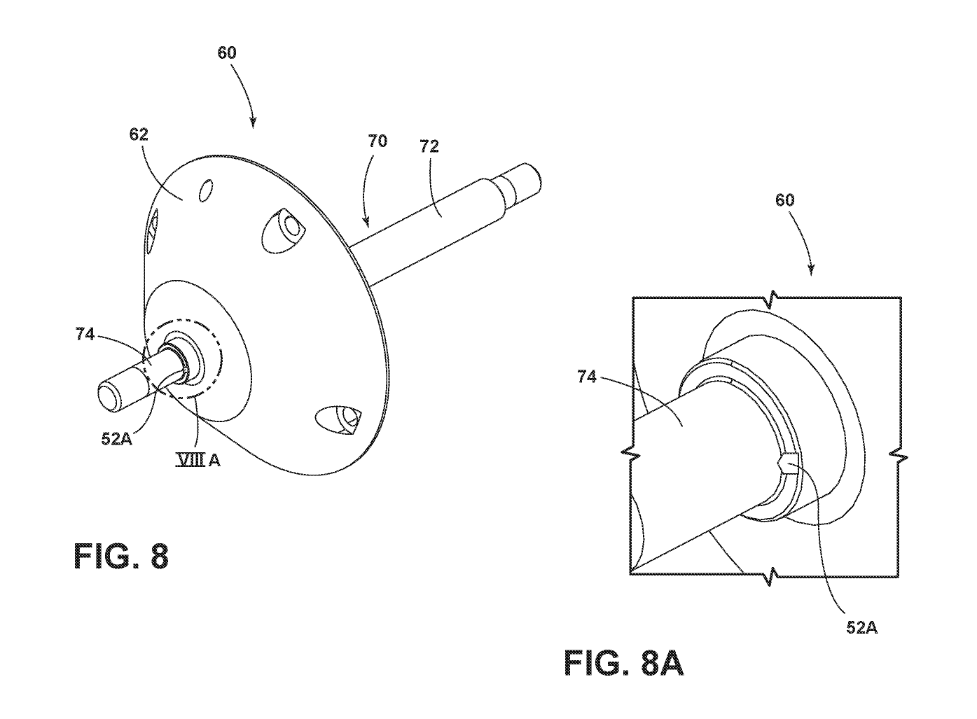

In embodiments, such as generally illustrated in FIGS. 1, 8, and 8A, a piston 40 may be supported by a connecting member 70 such that movement (e.g., axial movement) of inner housing 80 and/or connecting member 70 causes movement of piston 40. Piston 40 may be connected to piston 40 via a keyed engagement 52 such that piston 40 cannot rotate relative to connecting member 70, which may prevent piston 40 from rotating relative inner housing 80, piston retainer 60, and/or housing 20. For example and without limitation, connecting member 70 may include a male element 52A configured to be received by a female element 52B (e.g., a recess) of piston 40. Female element 52B may be disposed in inner portion 48 of piston 40.

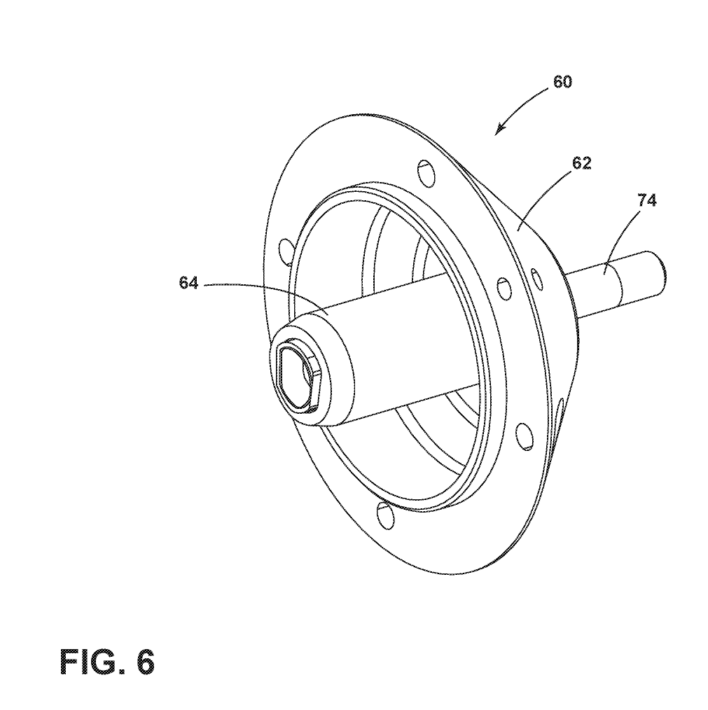

With embodiments, such as generally illustrated in FIGS. 6, 7, 7A, 8, and 8A, connecting member 70 may be at least partially integrated with piston retainer 60. For example and without limitation, a first portion 72 of connecting member 70 may connect with inner housing 80 and with collar 64. A second portion 74 of connecting member 70 may be disposed at least partially in body 62 and/or collar 64 and may extend from an opposite side of piston retainer 60 to connect with and/or support piston 40. Movement (e.g., axial movement) of first portion 72 may cause movement of second portion 74, which may cause movement (e.g. opening/closing) of piston 40.

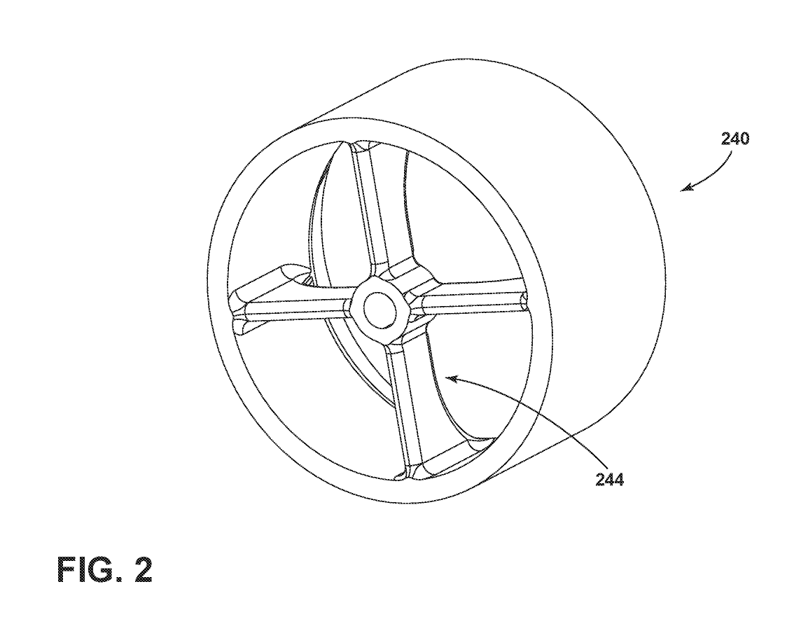

Compared to other designs, embodiments of piston 40 may provide improved wear characteristics. For example and without limitation, in some designs, support members 244 may be solid, such as generally illustrated in FIG. 2. If a fluid coupler 10 is used with a piston 240 having solid support members 244, fluid may act on the support members 244 to a greater degree (e.g., as a result of greater surface area), and if the forces of such fluid are large enough to overcome a sealing force between piston 240 and housing 20 (and/or a seal there between), piston 240 may rotate. Housing 20 may include a stronger and/or harder material than piston 240 and such rotation of piston 240 may cause damage (e.g., scoring) of piston 240. Such damage may, over time, restrict the ability of the piston 240 to move axially, which may cause the piston 240 to get stuck in an open position, stuck in a closed position, and/or stuck between open and closed positions. Apertures 46 in support members 44 of a piston 40 may reduce the amount of torque/force acting on support members 44. For example and without limitation, the torque from fluid acting on a piston 40 may be three times less than a piston 40 without apertures 46 (e.g., piston 240).

In embodiments, such as generally illustrated in FIG. 9, fluid coupling 10 may include a flow straightener 90. Flow straightener 90 may, for example, be provided via piston 40. For example and without limitation, support members 44 of piston 40 may be disposed to straighten the flow of fluid that flows to piston 40. In embodiments, a piston 40 may include a plurality of support members 44, such as, for example and without limitation, at least three support members, at least six support members, at least eight support members, and/or other numbers of support members. The support members 44 may be equally circumferentially-spaced about an inner circumference of piston outer wall 42 and/or about inner portion 48. Support members 44 may or may not be configured the same as each other. Straightening the flow of fluid may reduce a side load experienced by piston 40, which may reduce the amount of contact and/or the force of contact between piston 40 and housing 20. In embodiments, flow straightener 90 may be separate from support members 44 and/or from piston 40 (e.g., may be a discrete component disposed between inlet 22 and outlet 30).

With embodiments, fluid coupler 10 may be used in connection with a fuel cart and may be configured for connection with a hydrant pit valve 100 for fueling and/or defueling of aircraft 110 and/or other vehicles. Fluid coupler 10 may be used with jet fuel, for example, which include a density of about 805.45 kg/m³ and a dynamic viscosity of 1.15E⁻³ Pa−s, and may be used at an operating temperature of about 75° F., in embodiments. Flow at inlet 22 may, for example, be about 1200 gallons per minute. Fluid pressure at outlet 30 may be relatively low and may approach or be about, for example, 0 psig.

With embodiments, one or more portions of a fluid coupler 10 (e.g., a piston 40, a piston retainer 60, etc.) may be formed via additive manufacturing.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A fluid coupler, comprising:
a housing including an inlet port and an outlet port;
a piston disposed in the housing and configured to control fluid flow between the inlet port and the outlet port; and
a piston retainer disposed in the housing;
wherein the piston includes at least one radially-extending support member, and a radially-extending support member of the at least one radially-extending support member includes an aperture.

2. The fluid coupler of claim 1, wherein the at least one radially-extending support member is substantially planar.

3. The fluid coupler of claim 1, wherein the at least one radially-extending support member is substantially parallel to a plane defined by an axial direction and a radial direction relative to a central axis of the piston.

4. The fluid coupler of claim 1, wherein the at least one radially-extending support member includes four radially-extending support members.

5. The fluid coupler of claim 1, wherein the aperture includes a first portion and a second portion, and the first portion includes a greater axial extent than the first portion.

6. The fluid coupler of claim 1, wherein the aperture includes a radial extent that is at least half as a radial extent of the radially-extending support member.

7. The fluid coupler of claim 1, wherein the piston is keyed with a connecting member; and the connecting member is disposed at partially in an inner portion of the piston and at least partially in a collar of the piston retainer.

8. The fluid coupler of claim 1, wherein the piston is configured to translate within the housing and is prevented from rotating relative to the housing.

9. The fluid coupler of claim 1, including a fluid straightener.

10. The fluid coupler of claim 9, wherein the piston is configured as the fluid straightener, the at least one radially-extending support member includes at least six radially-extending support members equally circumferentially-spaced about at least one of (i) an inner surface of an outer wall of the piston and (ii) an inner portion of the piston.

11. A piston for a fluid coupler, the piston comprising:
an outer wall including a cylindrical configuration;
an inner portion; and
a plurality of support members extending between the cylindrical outer wall and the inner portion;
wherein at least one of the plurality of support members includes an aperture.

12. The piston of claim 11, wherein the at least one support member is radially-extending and is substantially planar.

13. The piston of claim 11, wherein the at least one support member is substantially parallel to a plane defined by an axial direction and a radial direction relative to a central axis of the piston.

14. The piston of claim 11, wherein the plurality of support members includes at least three support members.

15. The piston of claim 11, wherein the aperture includes a first portion and a second portion, and the first portion includes a greater axial extent than the first portion.

16. The piston of claim 15, the second portion includes a greater radial extent than the first portion.

17. The piston of claim 15, wherein the first portion is disposed at a first distance from the outer wall, the second portion is disposed at a second distance from the outer wall, and the second distance is greater than the first distance.

18. The fluid coupler of claim 11, wherein the aperture includes an L-shaped configuration.

19. The fluid coupler of claim 11, wherein the aperture includes a radial extent that is at least half as great as a radial extent of the at least one support member.

20. The fluid coupler of claim 11, wherein the inner portion includes a recess configured to engage a key of a connecting member.
